(19) United States
(12) Patent Application Publication
(10) Pub. No.: US 2019/0208945 A1
(43) Pub. Date: Jul. 11, 2019

(54) Pressure-Controlled Sous-Vide Cooking Method and Appliance

(71) Applicant: Hans J. MEIER, Broxburn, Scotland (GB)

(72) Inventor: Hans J. MEIER, Broxburn, Scotland (GB)

(21) Appl. No.: 16/301,851

(22) PCT Filed: Mar. 20, 2017
(86) PCT No.: PCT/CA2017/000060

§ 371 Date: Nov. 15, 2018

Related U.S. Application Data
(60) Provisional application No. 62/496,756, filed on Oct. 28, 2016.
(60) Provisional application No. 62/391,965, filed on May 17, 2016.

(51) Int. Cl. A47J 27/08; A47J 27/086; A47J 37/06; A23L 5/10; A23L 5/30; A23L 13/70

(52) U.S. Cl. CPC A47J 27/0802; A47J 27/086; A47J 27/0804; A23V 2002/00; A23L 5/17; A23L 5/30; A23L 13/70; A47J 37/0611

(57) ABSTRACT

A method for cooking and curing a food item comprises; sealing the food item in a plastic bag with a flavoring sheet, and applying pressure and heat on that food item. The step of applying pressure and heat includes controlling a pressure according to a pressure setting corresponding to a nature of the flavoring sheet, or to the ingredients in the flavoring sheet or to both. These pressure settings are also related to a nature of the food item, and/or to the cooking temperature. The sous-vide cooking appliance used for carrying that method comprises an inflatable membrane mounted against the heating surface for covering the heating surface and the food item. An air pump and pressure regulator are used to precisely adjust the pressure-temperature relation and the function of that relation during cooking, for promoting a flavor transfer between a flavoring sheet and the albumins of the meat being cooked.

This application claims the benefit of U.S. Provisional Application No. 62/391,965 filed May 17, 2016, and U.S. Provisional Application No. 62/496,756 filed Oct. 28,2016.

### FIELD OF THE INVENTION

This invention pertains to cooking appliances and methods for controlling pressure, temperature and flavoring of food items during a cooking process.

### BACKGROUND OF THE INVENTION

Flavor sheets are used for curing or marinating meat portions or other food items. A meat portion, for example, is packaged together with a flavor sheet, in such a way that the flavor sheet is in direct contact with the meat. The meat portion is cured or marinated during storage in a refrigerator, or in a refrigerated transport during delivery to the client.

These flavor sheets are made of a substrate suitable for contact with food. A treatment layer is deposited onto the substrate. This treatment layer comprises a pre-determined amount of edible adhesive and a curing or marinating agent mixed in or otherwise retained to the substrate by the adhesive. When the meat is wrapped and packaged with a flavor sheet, the meat is in intimate contact with the food treatment layer of the flavor sheet. The adhesive dissolves in contact with the meat to release the curing or marinating substance onto the surface of the meat portion, for absorption into the meat portion. A flavor of smoked meat for example cast be obtained without smoking the meat. A flavor of maple-wood grilled steak for example can be obtained without grilling the steak. The flavor of frying or roasting can be obtained without frying or roasting the meat.

The flavor sheet technology can now infuse food with not only flavor but also a whole new set of food standards including visual and aromatic appeal; shelf life extension; nutritional improvements which can be expanded to, spices, salt, vitamins, minerals, fatty acids, and other nutritive supplements. The words curing, marinating and flavoring are used interchangeably herein to designate all the above food improvements.

Other benefits of flavoring sheets are disclosed in the publication: U.S. Pat. No. #6,623,773, issued to Hans J. Meier on Sep. 23,2003.

In another aspect in the preparation of food delicacies, “sous-vide” cooking is a method for cooking food that maintains the integrity of ingredients by heating them for an extended period of time at relatively low temperatures.

It is knows that food cooked in a “sous-vide” environment may result in food that has been cooked more uniformly throughout when compared with food prepared by other cooking methods. It has been taught that food cooked by sous-vide cooking methods have better flavors, texture, or nutritional value than food cooked by frying or grilling for example.

Some aspects of sons-vide cooking appliances are described in the following publications:

U.S. Pat. No. 8,833,245 issued to E. Alipour on Sept. 16, 2014.

U.S. Pat. No. 9,282,846 issued to E. Alipour et al., on Mar. 15, 2016.

A sous-vide cooking appliance as described therein creates a vacuum around the food item and brings a heat transfer membrane in direct contact with the food item. The heat transfer medium in contact with the membrane is often a liquid. Generally, food is placed in a plastic bag, sealed under vacuum inside the bag. Heated water is circulated against the exterior of the plastic bag to cook the food inside the bag. Cooking is done for a long period of time, sometimes up to 24 hours at temperatures that are well below the boiling point of water, typically around 60-70°C. It is claimed that because the air is removed from the bag, a better control of the heat transfer can be maintained.

Because the food is cooked in an airless environment, it is easier to maintain an ideal core temperature for that food. The airless environment eliminates the effect of gas pressure inside the cooking chamber and any associated fluctuation in temperature.

Theoretically, if no air or other gases is present in the sealed package, there is no gas to inflate the bag upon heating and to reduce heat transfer through the bag. More importantly, the law of Thermodynamics teaches that pressure-temperature-volume (pvT) and interdependent from each other in a heat exchange process. An increase in temperature causes the pressure to rise, and an increase in pressure causes the temperature to increase. Therefore, the presence of air in a cooking container causes an increase in pressure in that container during the cooking process, and causes the temperature to fluctuate to an unknown value. One purpose of a “sous-vide” cooking process, is to eliminate internal pressure due to air (airless) and to control volume so that temperature of cooking is better known and controlled.

Because of the low-temperature cooking in a sous-vide appliance, this method of cooking food has its inconvenience. For example, it is difficult to impart an open-fire-grilled taste to a piece of steak that has been cooked in a sous-vide appliance. This drawback has been solved by partly cooking the meat in a sous-vide appliance and finishing the cooking on an open-fire grill to sear the meat and to impart the meat with the desired taste and texture. This solution lengthens the cooking process and adds an extra step to a recipe.

Another drawback with sons-vide cooking methods is the absence of pressure on the meat. The absence of pressure on the meat has the adverse effects on some meats are prone to hardening. The heat from cooking causes connective tissues Horn these meats to contract. The heat from cooking causes the hardening of the meats, making them less tender and less succulent.

Also, a perfect vacuum is difficult to obtain. A pressure from residual gases inside the plastic bag is affected by altitude above sea level, by atmospheric pressure and by the cooking temperature. Because of this, basically, it becomes difficult to control precisely the pressure inside the plastic bag and the amount of water and juice released from the food during a sous-vide cooking process. This could render the food dry and less succulent. It also becomes somewhat difficult to control the degree of doneness of cooked food in a sous-vide cooking process by controlling only the temperature of a heat transfer medium, and not the residual pressure inside the cooking envelope.

Although the inventions found in the prior art deserve undeniable merits, it is believed that there is a need in the culinary industry for an-appliance and method that are compatible to the use of flavor sheets ins a sous-vide cooking environment.

### SUMMARY OF THE PRESENT INVENTION

In the present invention there is provided an appliance and a method of cooking food using flavor sheet technology in a waterless, pressure-controlled sous-vide appliance.

In a first aspect of the present invention, there is provided a method for cooking and flavoring a food item. This method included the steps of: sealing the food item in a plastic bag with a flavoring sheet; and applying a pressure and heat on that food item for a cooking time period. The step of applying a pressure and heat includes controlling a pressure according to a pressure setting corresponding to a nature or to the ingredients in said flavoring sheet, or to both.

In another aspect of the present invention, the step of applying also comprises the step of applying a pressure and heat temperature that have a relation with each other and with a cooking time period. The step of applying a pressure and heat also comprises varying that pressure and temperature according to that relation, as a function of the cooking time period. That relation and this function are selected from settings corresponding to a nature of the food item being cooked.

When the food item is meat for example, the pressure-temperature relation and function are selected for causing an optimum amount of albumins to exude from the meat; to contact the flavoring sheet, to entrap the flavoring substance from the sheet and to be absorbed back into the meat.

In another aspect of the present invention, there is provided a cooking appliance for cooking food items. The cooking appliance comprises a heating surface for receiving a food item thereon, and an inflatable membrane mounted against the heating surface for covering the heating surface and the food item. A locking device is included for retaining the inflatable membrane against the heating surface. The cooking appliance also comprises an air pump device incorporated therein for inflating the inflatable membrane and for applying a controlled pressure on the food item being cooked.

When cooking is done with a flavoring sheet in contact with the food item, the pressure created on the food item causes food juices to be brought to the surface of the food item and to dissolve with and to encapsulate flavoring substance from the flavoring sheet.

Depending on the calibration of the flavoring sheets, an endless variation of culinary objectives can be achieved, ranging from a simple topical seasoning to complex marinating, aromatic improvement, smoking, stewing, roasting, glazing and crusting.

In another aspect of the cooking appliance according to the present invention, the cooking appliance further comprises a pressure regulator for precisely controlling the air pressure inside the inflatable membrane. Such pressure regulator provides, to a certain extent, the ability to control a depth from which food juices are brought out of the food item.

The cooking appliance according to the present invention can be used with flavoring sheets to prepare delicious dishes such as, for examples only; BBQ™ proteins, smoked salmon, Gravid Lux™ stews, roasted chicken, pot roasts, seafood with white sauce, or seasoned pork chops.

In yet another aspect of the present invention, the cooking appliance further comprises a bag sealing device mounted near the heating surface thereof for selectively sealing the food item so a plastic bag.

While pressure-controlled sous-vide cooking is an important aspect of the present invention, the cooking appliance can be used to vacuum-seal a food item in a bag for freezing and storage for examples.

In yet a further aspect of the present invention, the cooking appliance also comprises a mini-refrigeration system mounted in the lid thereof. This mini-refrigeration system is used for selectively cooling the inflatable membrane and the food item inside the cooking appliance. A food item can be sealed, cooled and stored inside the cooking appliance until meal time.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the pressure-controlled sous-vide cooking appliance according to a preferred embodiment of the present invention is described with the aid of the accompanying drawings, in which like numerals denote like parts throughout the several views:

FIG. 1 is a perspective top view of the sous-vide cooking appliance according to the preferred embodiment of the present invention, shown with a piece of meat being readied for cooking;

FIG. 2 is a broken-away perspective top view of the sous-vide cooking appliance according to the preferred embodiment of the present invention, with the lid thereof fully open;

FIG. 3 is another perspective view of the sous-vide cooking appliance according to the preferred embodiment of foe present invention shown in a closed mode;

FIG. 4 is a detached side view of the sous-vide cooking appliance according to the preferred embodiment of the present invention;

FIG. 5 is a cross-section view of the food package in FIG. 1, as seen along line 5-5 in FIG. 1;

FIG. 6 is an enlarged view of a portion of the food package in FIG. 1, as seen in detail circle 6 in FIG. 5.

The drawings presented herein are presented for convenience to explain the functions of all the elements includes in the cooking appliance according to the preferred embodiment of the present invention. Elements and details that are obvious to the person skilled in the art may not have been illustrated. Conceptual sketches have been used to illustrate elements that would be readily understood in the light of the present disclosure. These drawings are not fabrication drawings, and should not be scaled.

### DESCRIPTION OF THE PREFERRED EMBODIMENT

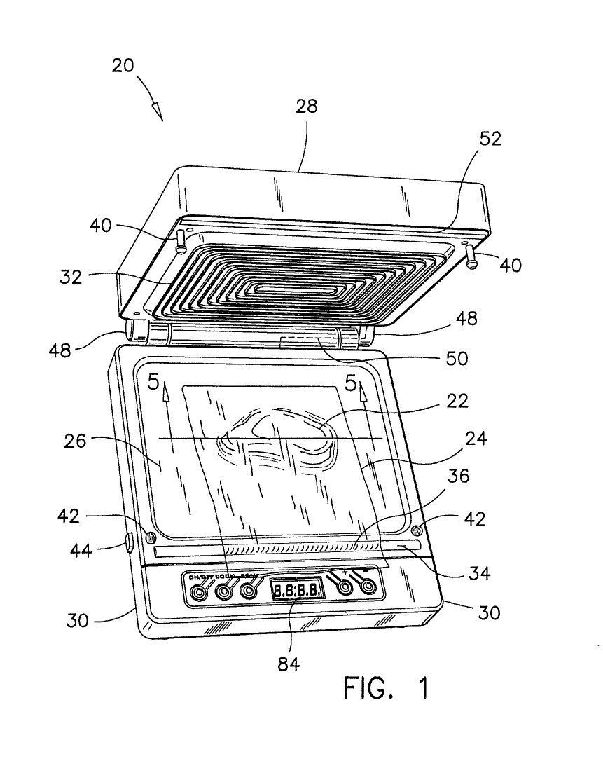

Referring firstly to FIG. 1 the preferred pressure-controlled sous-vide appliance, referred to herein as the sous-vide appliance 20 is illustrated at an interim point during a cooking process. A piece of food item 22 is placed in a plastic bag 24 and set on the resilient heating pad 26. In use, the lid 28 is closed over the base member 30. The deformable membrane 32 of the lid is inflated, flattening the plastic bag 24 and the food item 22, and evacuating the air from inside the bag 24. The heat-sealing bar 34 is activated to seal the bag 24 at its opening 36 in an airless, vacuum-like condition.

After the bag 24 has been sealed over the food item 22, the lid 28 of the appliance is locked in a closed position over the base member 30 and the cooking cycle can be started.

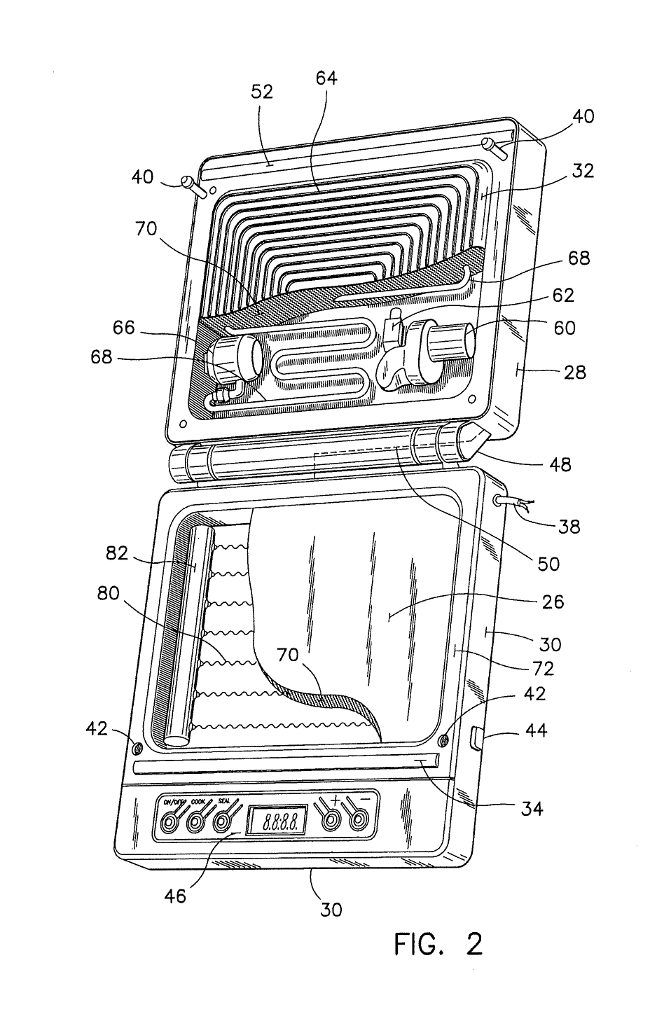

Referring to FIG. 2, the overall arrangement of the preferred sous-vide appliance 20 is illustrated therein. The sous-vide appliance 20 has a clamshell design with a lid 28 and a base 30. The lid 28 has a pair of lock pins 40 on its inside surface. These pins 40 engage into a corresponding pair of holes 42 in the upper surface of the base member 30. Release buttons 44 in the sides of the base member 30 are used to release the lock pins 40 from a locking mechanism (not shown) mounted inside the base member 30. Although a pair of lock pins 40 and associated mechanisms are mentioned herein, it will be appreciated that other case locking devices can be used to retain the lid 28 tightly against the base member 30.

Referring again to FIG. 2, the base member 30 has a heating pad 26 therein which preferably has a reflective upper surface that is relatively rigid. Alongside the heating pad 26, there is illustrated the heat-sealing bar 34. This bar is operated on 12 volts DC power and has capacity to seal common plastic bags. Next to the heat-sealing bar 34 is mounted the control display pad 46 and circuitry of the appliance. A battery (not shown) is preferably mounted in the base member 30 under the display pad 46 and circuitry of the appliance. A computer including a memory is also preferably included in the base 30 under the control pad 46. The preferred sous-vide appliance 20 also has a battery charger (not shown) therein, which has an electrical supply cord 38. This cord 38 is partly illustrated along the right hand side of the base 38 in FIG. 2.

The lid 28 has a flexible inflatable membrane 32 thereon. This membrane 32 comes in contact with the heating pad 26 of the base member 30, when the lid 28 is closed over the base member 30. The lid 28 is movably retained to the base member 30 by a hinge 48.

Wiring and tubing between the base member 30 and the lid 28 are routed through that hinge 48 as indicated by dashed line 50.

The display pad 46, controls and instrumentation of the preferred sous-vide appliance 20 comprises an on/off button; a cook mode button; a bag seal mode button; a clock and a plus and minus buttons to set the clock and the cooking time, to change cooking modes; and temperature and pressure modes. The instrumentation mentioned above also include at least one temperature sensor, a pressure sensor and a timer. The electronic circuits for all these functions are enclosed in the front portion of the base member 30, underneath the display pad 46.

The preferred sous-vide appliance 20 is operable as a sous-vide appliance providing cooking temperate of up to 80° C. The preferred sous-vide appliance 20 is also operable as a vacuum packaging device. In the vacuum packing mode, the sous-vide cooking features of the preferred sous-vide appliance 20 are advantageously used to evacuate air from a package. A pair of heat-sealing bars 34 and 52 are used to seal the package while it is maintained under an airless state.

The lid 28 preferably contains a mini air compressor 60 and an electronically-controlled precision mini air pressure regulator 62 for controlling the degree of inflation of the membrane 32 and the pressure to be applied to the food item being cooked. The inflatable membrane 32 is made of concentric ridges 64 extending from the outside surface of a flexible skin-like material. It will be appreciated that the flexible membrane 32 is made of a washable, heat-resistant, food-grade silicon or latex material for example.

The lid 28 also preferably contains a mini-refrigeration unit 66 and an associated refrigerant tubing array 68. The tubing array 68; the refrigeration unit 66; the air compressor 60 and the pressure regulating valve 62 are preferably enclosed in a layer of porous, sponge-like heat conductive material 70. The membrane 32 is sealed to the lid 28 along its perimeter to form with the lid 28 an inflatable bladder.

The membrane 32 is inflatable to apply a pressure against a piece of food in a plastic bag, by way of the mini-air compressor 60 and the electronic pressure regulator 62.

The base member 30 may have a similar inflatable bladder mounted therein facing the membrane 32. In the preferred embodiment, the base member 30 has a heating plate 26 which is substantially rigid and has a reflective surface thereon. The heating plate 26 is preferably set somewhat lower than the rim 72 of the base member 30, so as to form a shallow receptacle on the surface of the base member 30.

An array of heating elements 80 and bus bars 82 are preferably mounted in the base member 30 under the heating plate 26. The heating elements 80 and the bus bars 82 (only one is shown), are enclosed in a porous, sponge-like heat conductive material 70 as the material used in the lid 28. It will be appreciated that other heat sources can be used. For example, the heat source may be a circulating hot gas, hot water or steam.

The beating plate 26 in the base member 30 may include a pressurized, non-expandable bladder (not shown) that is inflated at a basic pressure of 3 psi, for example.

All the elements included in the base member 30 and the lid 28 are heat resistant, capable of withstanding temperatures of more than 80° C. without damage. A temperature sensor (not shown) for controlling the operation of the heating elements 80 is preferably mounted under the heating pad 26.

Referring back to FIG. 1, it will be appreciated that a plastic bag 24 with a food item in it, a steak for example 22, is flattened upon closing of the cover 28 over the base member 30. The air inside the bag 24 is forced out, and the food item 22 inside the bag is maintained in a “sous-vide” condition as long as the cover 28 is closed and locked against the base member 30. This food item 22 can be cooked at very low temperature of around 80° C. A timer 84 is used to control the cooking time. Preferably, this food item 22 is maintained under a pressure of about 1-4 psi., during the entire cooking period. This pressure setting is provided herein as an example only, as this setting will be explained further herein below. The air pump 60 and regulator 62 can be used to inflate the pressurized bladders 32 to pressure higher or lower than 4 psi., if needed.

In a preferred embodiment, the pressure in the bladder 32 can be varied between 0-60 psi. The temperature of cooking can be adjusted from 50° C. to 80° C. in a residential model, and between 50° C. and 100° C. in a commercial or industrial model.

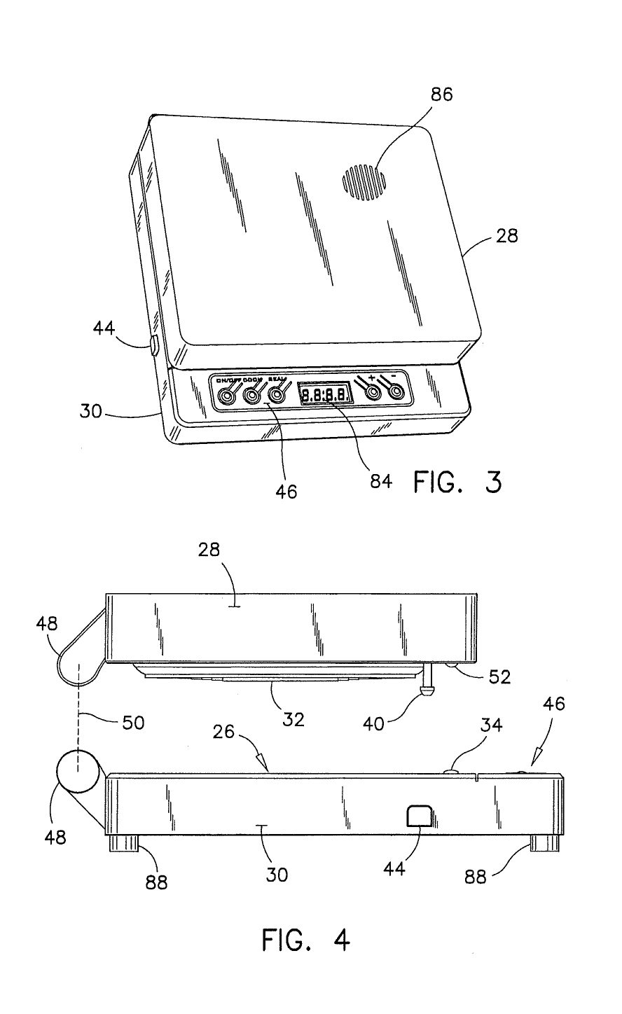

Referring now to FIGS. 3 and 4, the preferred sous-vide cooking appliance 20 is illustrated in different views to show the elements of the appliance in alternate viewing angles. The array of slots 86 in FIG. 3, represents an air opening for the mini compressor 60. The bosses 88 under the base member 30 of the appliance in FIG. 4 represent legs to support the base member 30 over a horizontal surface.

Because the preferred sous-vide cooking appliance 20 has the ability to control the pressure surrounding the bag and the food item inside a bag, new culinary objectives can be contemplated. The preferred sous-vide appliance 20 can be used with flavor sheets as mentioned herein before.

Referring now to FIGS. 1, 5 and 6, a method of imparting flavor to a food item during cooking will be explained.

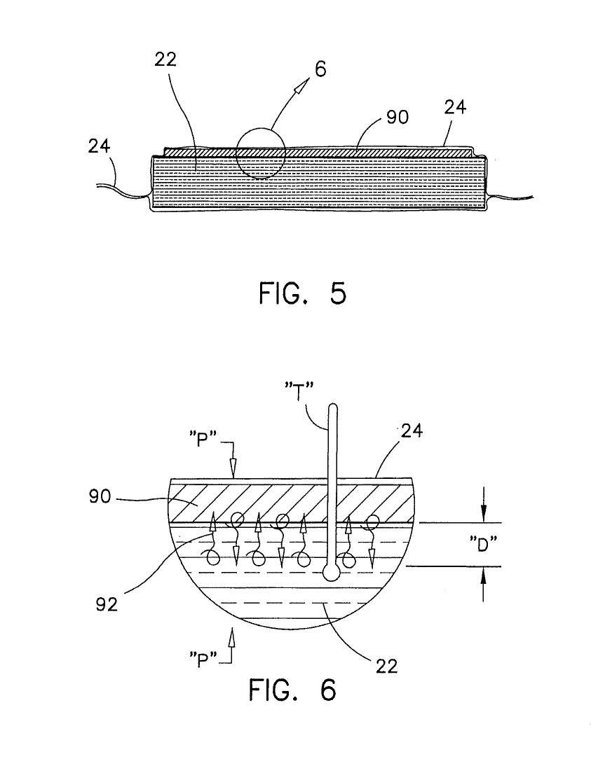

A preferred preparation for food item 22 is illustrated in FIG. 5. The food item 22 is covered by a flavor sheet 90 and sealed airless in a plastic bag 24. The illustration in FIG. 6, explains the exchange of flavoring particles to the food item. As the temperature “T” increases in the food item 22, the pressure inside the food item also increases because of a natural relationship between pressure and temperature in a fixed volume. Because of this increased pressure, the juices, as represented by label 92, that are present in the food item exude or weep out of the food item 22 when the plastic bag 24 is held on all sides and prevented from expanding.

These juices 92 exude from the surface of the food item and mix with the flavoring substance at the surface of the flavoring sheet 90. When the food item 22 is meat or other protein-based food, the juices 92 contain albumins. Preferably the adhesive of the flavor sheet contains an acid, sorbic acid for example. The acid present in the adhesive of the flavoring sheet causes these albumins to coagulate and to entrap therein the flavor particulate of the sheet. Because of the movement of the juices occurring at the surface of the meat during cooking, the coagulating albumins and flavor particulate are entrapped into the meat, surface. The pressure inside the inflatable membrane 32, and the corresponding pressure “P” applied to the food item 22, determines the depth “D” of penetration at which the food juices 92 are driven out from the meat, and back into the surface of the meat.

It will be appreciated that hot regions at the surface of a food item being cooked comprises microscopic regions of higher and lower temperature; and microscopic regions of higher and lower pressure. This effervescence-like regions help to absorb the coagulated albumin and encapsulated flavoring substance, back into the meat.

In order to further promote the absorption of flavoring substance deep in the food surface, the pressure “P” inside the pressurized bladder 32 can be relaxed and increased alternately or at the end of the cooking cycle. The cooking temperature “T” can also be relaxed and increased alternately or at the end of the cooking cycle to produce a similar effect.

The food items cooked in the preferred pressure-controlled sous-vide cooker remain moist and succulent, and a better degree of flavor transfer is obtained.

As mentioned before, pressure-temperature-volume (pvT) are interdependent from each other in a heat exchange process. Another variable is cooking time. In the pressure-controlled sous-vide cooking process according to the preferred embodiment of the present invention, the volume of the food item is kept constant, under pressure. Pressure is therefor interdependent with temperature and cooking time only.

In such a process, cooking time and temperature are important factors to obtain doneness and tenderness of a food item. Cooking time and temperature are depending on the size and type of food item being cooked. Pressure is an important factor to obtain the flavor and appearance of a food item. Pressure determines whether a flavor is absorbed superficially or deeply into the food item. Pressure is dependent on the type of food being cooked as well as on temperature, cooking time and the type of flavoring sheet used. Pressure also prevent contraction of connective tissues in meats that are prone to hardening.

In the pressure-controlled sous-vide cooking process according to the preferred embodiment of the present invention, temperature and cooking time are considered as a priority, or as dominant factors in a relation pressure-temperature, while pressure is considered as a secondary factor. When pressure is applied to the food item for flavor transfer, adjustment or correction is made if needed, to the temperature so that the temperature-cooking time product of a recipe remains unchanged.

Pressure is never increased to the point of, or at a moment wherein the food item can be over-cooked. Pressure can be increased, for example, at a moment when the food item is thoroughly hot and has sufficient entropy to tolerate a reduction of heat to accommodate an increase in pressure. Similarly, a relaxation of pressure can be accompanied by an increase of energy to the heater. In the pressure-controlled sous-vide cooking process according to the preferred embodiment of the present invention, a relation pressure-temperature, is a relation where temperature is a dominant factor. In other words, pressure and temperature are varied for obtaining a flavor transfer into the food item, for obtaining tenderness, and for maintaining constant a heat absorption by said food item during the cooking period

For examples, the following pressure settings in Table 1, are recommended for different proteins and different ingredients in the flavoring sheet used:

TABLE 1

| Protein type | Pressure Settings | |
|---|---|---|
| For tenderizing meat prone | 2-4 | psi. |
| to contraction during cooking | | |
| For marinating formulations | 2-4 | psi. |
| For herb and spice formulations | 1-1.5 | psi. |
| For chicken, fish and similar density protein | 1-1.5 | psi. |
| For steaks, chops, and similar density protein | 2-3 | psi. |

| | |
|---|---|
| For stews and sauces | less than 1 psi. |
| To increase exuded moisture | less than 1 psi. |

It will be understood that a higher pressure causes shorter cooking and marinating time periods. Pressure may also be varied during the cooking period of a same food item. For example, a higher pressure may be used for a portion of the cooking period and a lower pressure may be used during another portion to increase exuded moisture and obtain a sauce or gravy base.

The selectable relations between pressure and temperature, and the variation of these relations as a function of cooking time, are preferably established by chefs according to experiments carried out with the preferred pressure-controlled sous-vide cooking appliance 20. Corresponding cooking mode settings and cooking programs are developed and included in the memory of the controller of the preferred sous-vide appliance 20. These recipes can be selected by the user from the display pad 46.

For example, a recipe may include pressure-temperature settings and variations over a cooking time period for a specific size and nature of food item and a specific flavoring sheet. Such recipe may be developed for meat of different protein contents, different cut portions, different thicknesses, different size and weight, and different flavor and tenderness desired. These recipes are preferably pre-programmed in the control system of the preferred sous-vide appliance 20 through the display pad 46. These recipes are preferably selected by the user from a menu display, as a selectable window under the clock 84.

Furthermore, the preferred sous-vide cooking appliance 20 contains a mini-refrigeration system 66, 68, whereby a food item can be seated in an airless condition, refrigerated inside the appliance 20 and taking out as in a lunch box. The food item can be stored in a refrigerated state and cooked at a preset time and temperature mode to be readied at meal time.

1. A method for cooking and curing a food item, comprising the steps of:
sealing a food item in an airless mode with a flavoring sheet; and
applying pressure and heat on said food item for a time period;
wherein said step of applying includes:
controlling said pressure according to a pressure setting corresponding to a nature of said flavoring sheet.

2. The method for cooking and curing a food item as claimed in claim 1, wherein said step of applying also comprises controlling said pressure according to a pressure setting corresponding to ingredients in said flavoring sheet.

3. The method for cooking and curing a food item as claimed in claim 1, wherein said step of applying also comprises the step of controlling said pressure according to a temperature of said heat.

4. The method for cooking and curing a food item, as claimed in claim 1, wherein said step of applying includes:
controlling said pressure and heat temperature according to a relation between said pressure and said temperature and varying said pressure and said temperature according to a function of said time period.

5. The method for cooking and curing a food item, as claimed in claim 4 wherein said relation and said function are boing selected from a recipe corresponding to a nature of said food item.

6. The method for cooking and curing a food item as claimed in claim 5, wherein said relation between said pressure and said temperature is a relation where said temperature is a dominant factor and a heat absorption in said food item remains constant during a major portion of said time period.

7. The method for cooking and curing a food item as claimed in claim 1, wherein said step of sealing comprises placing said food item and said flavoring sheet in a plastic bag.

8. The method for cooking and curing a food item as claimed in claim 5, wherein said step of applying pressure on said food item comprises the steps of:
placing said plastic bag against a heating surface;
applying a deformable membrane against said plastic bag and said heating surface; and
retaining said deformable membrane at a fix distance from said heating surface; inflating said deformable membrane to said pressure.

9. The method for cooking and curing as claimed as claim 1, further including the step of selecting a flavoring sheet comprising an edible adhesive containing an acid.

10. The method for cooking and curing a food item as claimed in claim 9, wherein said food item is protein and further including the step of selecting a pressure-temperature relation for causing albumins to exude out from said protein, to contact said flavoring sheet, and to be absorbed back into said protein.

11. The method for cooking and curing a food item as claimed in claim 5, further including the steps of cooling said plastic bag and said food item between said inflatable membrane and said heating plate, while delaying said step of applying pressure and heat to said plastic bag.

12. The method for cooking and curing a food item as claimed in claim 5, wherein said pressure is alternately relaxed and increased during said step of applying pressure and heat.

13. A cooking appliance for cooking food items, comprising:
a heating surface for receiving one of said food items, and an inflatable membrane mounted against said heating surface, for covering said heating surface and said food item;
a locking device for retaining said inflatable membrane against said heating surface;
an air pumping device incorporated therein for inflating said inflatable membrane and for applying a pressure on said food item against said heating surface.

14. The cooking appliance as claimed in claim 13, further comprising a pressure regulator for controlling an air pressure inside said inflatable membrane.

15. The cooking appliance as claimed in claim 13, further comprising a bag sealing device mounted near said heating surface for selectively sealing said food item in a plastic bag.

16. The cooking appliance as claimed in claim 15, further having a clam shell design having a lid and a base member, and wherein said heating surface is mounted in said base member and said inflatable membrane is mounted in said lid.

17. The cooking appliance as claimed in claim 14, wherein said inflatable membrane is filled with a sponge-like heat conductive material.

18. The cooking appliance as claimed in claim 15, further comprising a mini-refrigeration system mounted in said lid, for selectively cooling said inflatable membrane and said food item.

19. The cooking appliance as claimed in claim 18, further including a battery therein for operating said mini-refrigeration system, said bag sealing device and said air pumping device.

20. The cooking appliance as claimed in claim 17, wherein said heating surface is supported by said sponge-like heat conductive material.

21. The cooking appliance as claimed in claim 13, wherein said inflatable membrane has concentric ridges on a surface thereof.

22. A cooking appliance, comprising:
a heating surface for receiving a food item, and an inflatable membrane mounted against said heating surface, for covering said heating surface and said food item;
a locking device for retaining said inflatable membrane against said heating surface;
an air pumping device incorporated therein for inflating said inflatable membrane and for applying a pressure on said food item against said heating surface;
a pressure regulator mounted therein for controlling air pressure inside said inflatable membrane;
a bag sealing device mounted near said heating surface for selectively sealing said food item in a plastic bag; and
a mini-refrigeration system mounted in said lid, for selectively cooling said inflatable membrane and said food item.

23. The cooking appliance as claimed in claim 22, further having a clam shell design including a lid and a base member, and wherein said heating surface is mounted in said base member and said inflatable membrane is mounted in said lid.

24. The cooking appliance as claimed in claim 22, wherein said inflatable membrane is filled with a sponge-like heat conductive material, and has concentric ridges on a surface thereof.
